(19) United States
(12) Patent Application Publication
(10) Pub. No.: US 2006/0151965 A1
(43) Pub. Date: Jul. 13, 2006

(54) Steerable tri-ski downhill rider

(76) Inventor: Jacobus Calitz, Chino Hills, CA (US)

Correspondence Address: Louis Bouwer;EzSki Inc., 13141 Central Ave.,, Suite A, Chino, CA, 91710, US

(21) Appl. No.: 11/033,064

(22) Filed: Jan. 10, 2005

(51) Int. Cl. B62B 13/00

(52) U.S. Cl. 280/16

(57) ABSTRACT

A ski riding apparatus comprises a horizontal platform mounted on three skis with one positioned rearwardly and two, in side by side positions forward. A steering column extends upwardly from the platform terminating with a steering brace. The rider stands on the platform leaning forward against the brace and in this position is able to lean from side to side to steer the apparatus. The forward end of the platform is rotationally engaged with a laterally extending ski support positioned forward of the platform. The ski support provides laterally spaced apart engagement elements with the dual front skis. By tilting the platform a sprocket is rotated within the ski support housing and by belt or chain drive, this sprocket rotates lateral ski sprockets for tilting the forward skis in coordination with the tilting platform.

### BACKGROUND OF THE INVENTION

1. Related Applications

none

2. Field of the Invention

This invention relates generally to downhill type ski equipment such as long skis, ski-boards, toboggans and sleds, and more particularly to a stand-on ski supported platform with steering achieved by lateral leaning.

3. Description of Related Art

The following art defines the present state of this field and each disclosure is hereby incorporated herein by reference:
Fredrickson, U.S. Pat. No. 1,946,018, describes a device comprising a fuselage frame, aerial steering means on said frame, propellers carried by said frame, an engine adjustably supported on the frame, endless belts between the engine and the propellers, runners pivotally connected to the frame, and means for tilting the runners and simultaneously actuating the aerial steering means.
Millis, U.S. Pat. No. 3,145,030, describes a ski sled comprising a traversely-extending cross frame; a longitudinally-extending, tiltable, medial body member rotatably attached medially to and extending rearwardly from said cross frame in T-shaped relationship thereto; a rear runner mounted beneath said body member; a normally vertical runner yoke tiltably mounted at each extremity of said cross frame in parallel relation to said medial frame; a front runner mounted on and beneath each runner yoke; a rider's seat mounted on said medial frame; two flexible guide elements extending from the rider's position on said seat forwardly and outwardly from said medial frame to a fixed connection adjacent each extremity of said cross frame so that alternating tension in said guide members will tilt said medial frame sidewardly relative to said cross frame; the axis of tilt between the runner yokes and the cross frame being inclined forwardly and downwardly at an angle of substantially 15 degrees from the horizontal; and the axis of rotation between the cross frame and the medial frame being inclined rearwardly and downwardly at an angle of substantially 15 degrees from horizontal; means pivotally mounting the forward portion of each front runner on its yoke; and adjustable mounting means mounting the rear potion of each front runner on its yoke so that said rear portion can be vertically adjusted to preset the front runners at any desired incline from the horizontal.
Leeming, U.S. Pat. No. 3,326,569, describes a sled comprising a body, a front ski rotatably connected to the front portion of said body, a pair of rear skis each connected to the rear portion of said body by at least one respective strut pivotally connected on one end to said body to permit movement of the strut about a longitudinal axis and connected on the other end to said ski, said strut disposed inwardly from said pivoted connection toward the longitudinal axis to cause said body, rigid linking means pivotally connected between said struts to maintain a specified separation therebetween, and means for pivoting said struts about the longitudinal axis to cause said body to tilt with respect to the terrain on which the sled rests.
Horiuchi, U.S. Pat. No. 3,398,970, describes a ski sled comprising a body, a front ski and a pair of rear skis coupled to said body, a rotatable steering shaft in said body at the front thereof, said front ski being connected to said steering shaft for rotation therewith, a bridge member pivotably connected to said body at the rear thereof, means supporting said rear skis from said bridge member in spaced relation on either side of said body, said means including an axle for each rear ski extending longitudinally thereof and supported from the bridge member to extend generally forwardly and upwardly such that the front ends of the rear skis are raised above the level of the front ski, said rear skis being rotatably mounted on their respective axles, link means connecting the body and said rear skis to enable the rear skis to follow inclination of the body and binding means on the rear skis for the shoes of a rider.
Zaimi, U.S. Pat. No. 3,682,495, describes a winter sports vehicle including a pair of front support ski-like runners each separately manipulatable by the vehicle operator to provide a vehicle motion control that is comparable to that utilized by a skier. The vehicle is disclosed in gravity, motor, and operator powered forms.
Scheib, U.S. Pat. No. 4,036,506, describes a sled on which two movable runners in front and two in back are mounted so that they can be tilted on a sled frame, so that the canting axes, running in the direction of travel, are primarily parallel over the sled's contact surface and the runners are connected with each other by at least one jointed parallelogram which transfers the tilting motion.
Strunk, U.S. Pat. No. 4,175,759, describes a winter sport device that includes a pair of elongated parallel skids, a user support upwardly spaced from the skids, and an arrangement mounting the support on the skids for tilting movement of the support about a first axis parallel to the elongation of the skids and for simultaneously converting the tilting movement into a corresponding tilting movement of the skids about a second axis paralleling the first axis.
Gibbons, U.S. Pat. No. 6,116,622, describes a steerable and brakable sled that comprises a body member having a passenger compartment and being mounted to a frame and upon a pair of skis each having a duckbill-shaped forward portion, and further comprises steering and braking controls, the steering controls including a steering member, a pair of steering arms connected to the skis for pivoting the skis on their edges which turn the sled in the desired direction, and the braking control including a braking arm connected to the steering member which is accessibly disposed inside the passenger compartment and connected to a plate-like braking member hingedly attached to the bottom side of the body member at the rear end thereof and having a corrugated edge for engaging the ground once the user pulls back on the steering member.
Dempster, U.S. Pat. No. 6,530,582, describes a steerable personal vehicle that may be used on snow, land and water. The steerable personal vehicle has a steering assembly and a frame. The steering assembly and the frame are connected by a joint about which either may be rotated relative to the other. The frame includes a rider support on which a rider may be mounted in a generally prone position. The steering assembly provides for rotation about three main axes, so as to provide stability and handling. The vehicle is mounted on a plurality of runners that may be attached thereto by front and rear suspensions. The runners may be formed as snow skis, water skis or wheel-mounting tracks.

Our prior art search with abstracts described above teaches: a sleigh, a sleds for snow and water, a ski sled, a snow bike, a tiltable sled, a winter sport device, a steerable and breakable sled, and a runner-mounted personal vehicle. This prior art shows, that it is known to provide down-hill sliding apparatus for riding. Clearly known elements include plural skis or runners, tilt for steering, tri-ski arrangements, steering using one forward ski or two forward skis, hinge mounted runners, and a chain-driven sprocket tilt drive. However, the prior art fails to teach a tri-ski apparatus with a platform for supporting a standing rider, where the forward end of the platform is engaged with a sprocket driving laterally positioned skis attached to a drive train for tilt type steering. The present invention fulfills these needs and provides further related advantages as described in the following summary.

### SUMMARY OF THE INVENTION

The present invention teaches certain benefits in construction and use which give rise to the objectives described below.

In a best mode preferred embodiment of the present invention, a ski riding apparatus for use in downhill riding on snow and wet grass, comprises a horizontal platform mounted on three skis with one positioned rearwardly and two, in side by side positions forward. A steering column extends upwardly from the platform terminating with a steering brace. The rider stands on the platform leaning forward against the brace and in this position is able to lean from side to side to steer the apparatus. The forward end of the platform is rotationally engaged with a laterally extending ski support positioned forward of the platform. The ski support provides laterally spaced apart engagement elements with the dual front skis. By tilting the platform a sprocket is rotated within the ski support housing and by belt or chain drive, this sprocket rotates lateral ski sprockets for tilting the forward skis in coordination with the tilting platform.

A primary objective of the present invention is to provide an apparatus and method of use of such apparatus that yields advantages not taught by the prior art.

Another objective of the invention is enable non-athletic persons experience the exhilaration of skiing downhill with little chance of hurting themselves.

A further objective of the invention is provide such an apparatus that is inexpensive to manufacture and yet easy to use and capable of being carried on a ski lift.

A still further objective of the invention is to provide such an apparatus that is easily broken down into a compact form for storage.

A still further objective of the invention is to provide such an apparatus that enables steering of frontal skis by leaning from one side to the other.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view of one embodiment of the invention;

FIG. 2 is a rear elevational view thereof with a steering column of the invention positioned normal to a supporting surface;

FIG. 3 is a front elevational view thereof with the steering column tilted to one side and a portion of a frontal ski support housing removed to disclose a chain drive of the invention;

FIG. 4 is a right side elevational view thereof;

FIG. 5 is also a right side elevational view thereof illustrating rotational freedom of three skis of the invention;

FIG. 6 is a further right side elevational view thereof shown with the steering column in a folded position; and

FIG. 7 is a further right side elevational view thereof showing disengagement of the frontal ski support housing and a rear portion of the invention.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

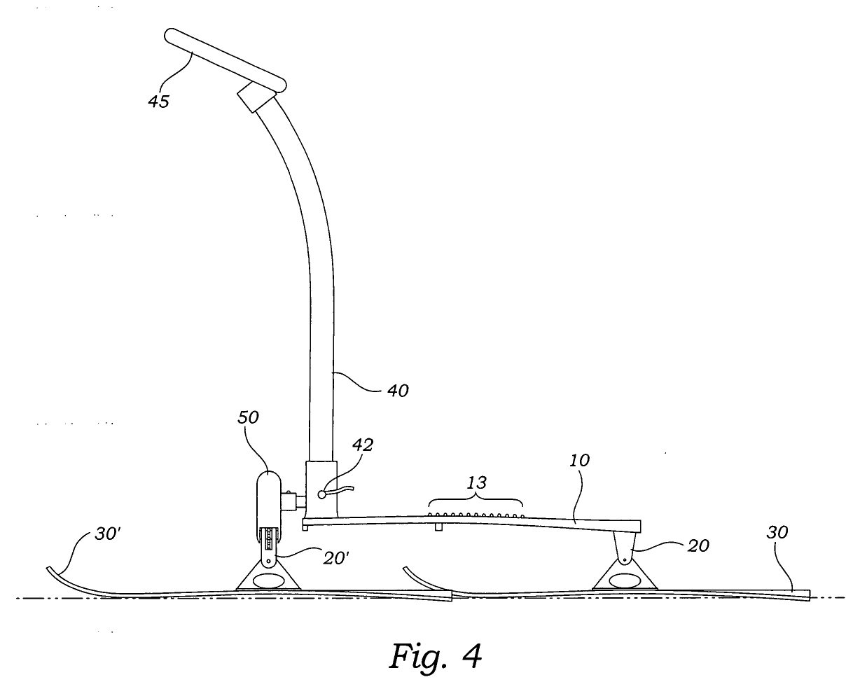

In one embodiment of the present invention a ski riding apparatus comprises a horizontal platform 10 having a forward end 12 and an opposing rearward end 14, and an up-facing surface 16 and an opposing down-facing surface 18. A rear attachment fixture 20 engages a rear ski 30 positioned under the platform 10 for support thereof. A steering column 40 is engaged with and extends upwardly from the platform 10 terminating with a steering brace 45. The brace 45 is conformal to the abdomen of a rider standing on the platform so that the rider may lean against the brace 45 and steer with his or her body leaning to one side or the other, which causes the column 40 and the platform 10 to tilt as well. The forward end of the platform 12 is rotationally engaged or coupled with a laterally extending ski support 50 positioned forward of the platform 10. The ski support 50 provides laterally spaced apart front attachment fixtures 20′ and 20″. Dual front skis 30′ and 30″ are each engaged with one of the front attachment fixtures 20′ and 20″ respectfully, thereby placing the dual front skis 30′ and 30″ in positions for supporting the platform, i.e., in a generally horizontal attitude as best seen in FIG. 4.

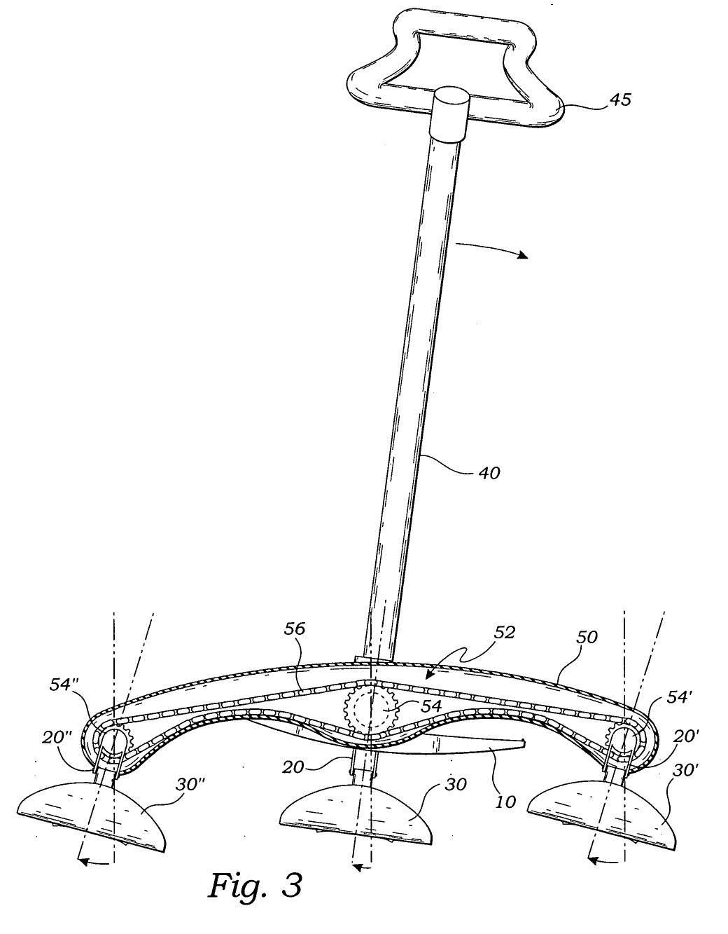

Preferably, the front attachment fixtures 20′ and 20″ are each pivotally engaged with the ski support 50 for laterally tilting the front skis 30′ and 30″ respectively as best seen in FIG. 3.

In this regard, the front attachment fixtures 20′ and 30″ are rotatable in a lateral sense for tilting the front skis, again, as seen in FIG. 3.

Preferably, the front attachment fixtures 20′ and 20″ are each engaged with a drive train 52, such as the chain drive and sprockets shown in FIG. 3. Here, primary sprocket 54 is rotated when the platform 10 is tilted through body leaning of the rider. A chain or belt or other mechanical or electomechanical drive element 56 transfers the rotational motion of sprocket 54 to laterally positioned ancillary sprockets 54′ and 54″ which are therefore reactive to tilting of the platform 10 so that with the platform tilting is able to tilt all of the three skis 30, 30′ and 30″. This is clearly shown in FIG. 3.

Preferably, the steering column 40 is enabled for rotation into contact with the platform 10 about pivot pin 42 so that the apparatus is more easily stored, i.e., in a more compact form.

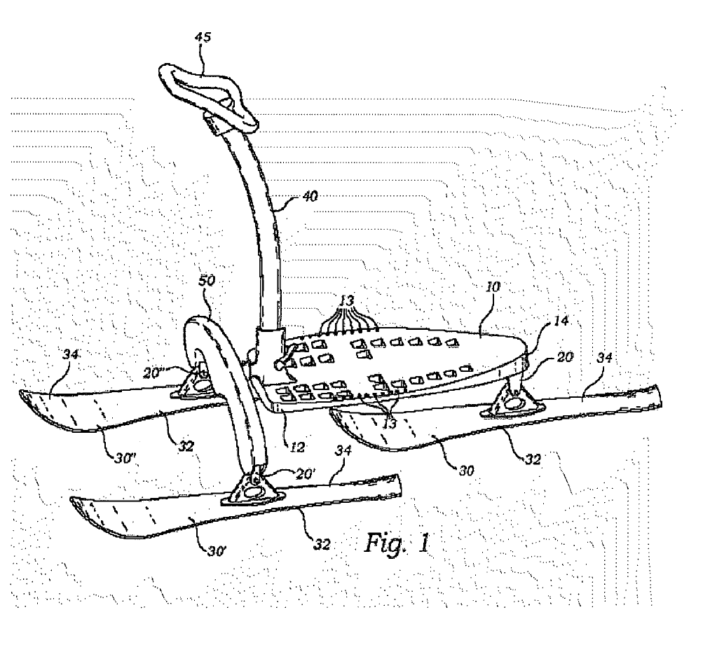

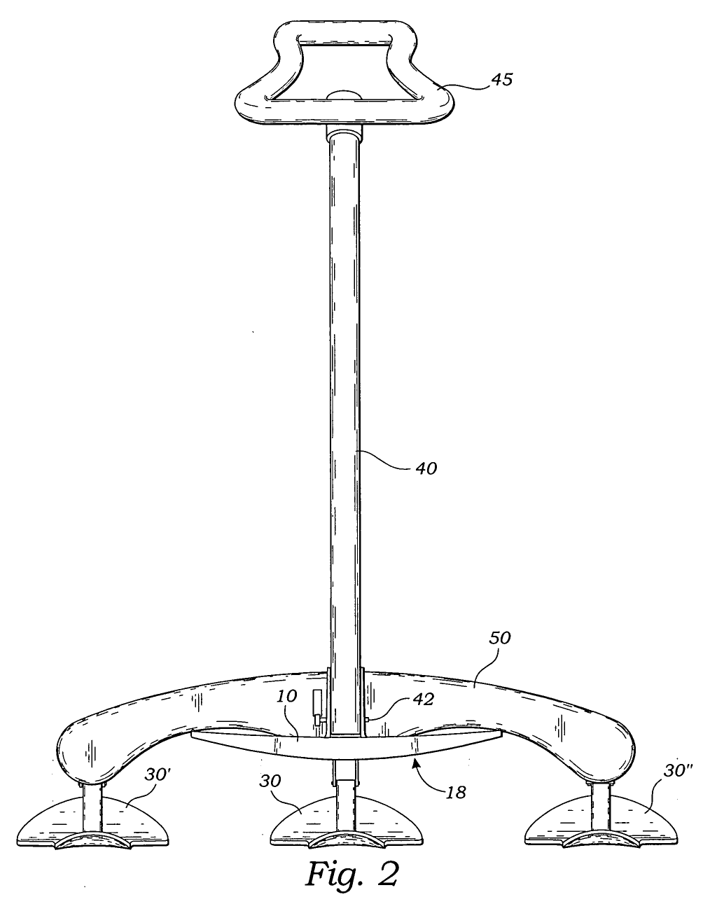

Preferably, the platform 10 provides plural apertures 11 therein, and a surface capable of scraping the sole of a foot wear, such as a shoe or boot. The scraping capability is achieved by a series of small protrusions 13 arranged along each side of the platform 10 on the upper surface 16 as clearly shown in FIG. 1.

Preferably, the skis 30, 30′ and 30″ each have a concave bottom surface so that the opposing side edges 32 and 34 of these skies tend to track straight when in their neutral orientation, and have an improved bit into soft surfaces when tilted. The concavity also lowers the friction force one the skis since less of the ski is in contact with the surface. Preferably, the opposing side edges 32 and 34 conform to a segment of a parabola and this curvature tends to induce steering forces to accentuate the steering capacity of the apparatus.

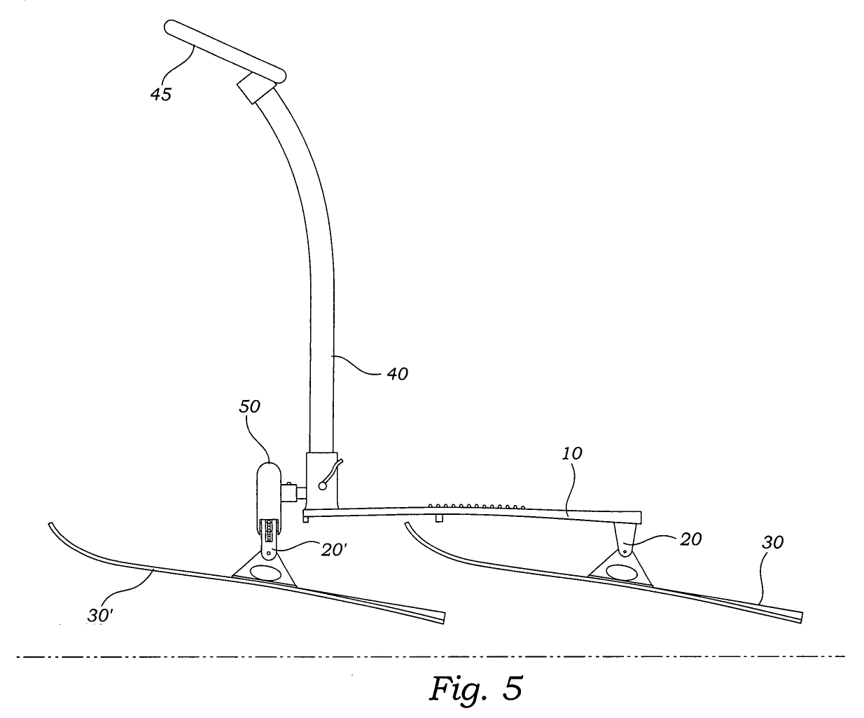

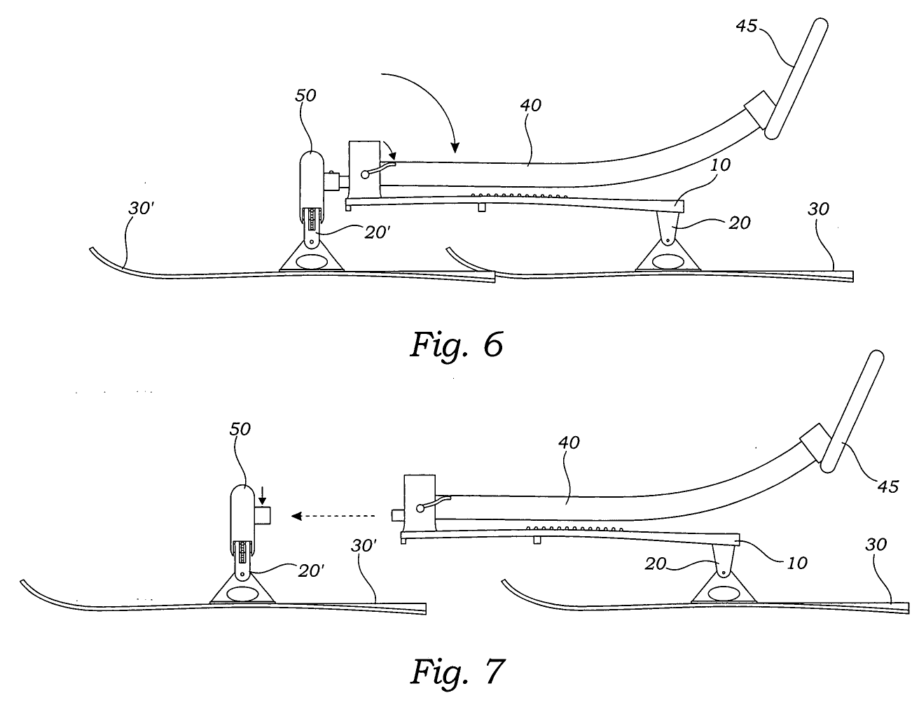

Preferably, the skis 30, 30′ and 30″ are each pivotally engaged with their respective attachment fixtures 20, 20′ and 20″ for axial rotation as shown best in FIG. 5 and these skis are weighted so as to tend to tilt back, as shown in FIG. 5, when off the supporting surface so that when rejoining the supporting surface there is less chance that the ski will stumble.

As shown in FIG. 7, the platform 10 is enabled for disassembly from the ski support 50, again for more compact storage of the apparatus.

In an alternate use of the above described invention, skis 30, 30′ and 30″ may be of an alternate type of use in water. In such a use the skis may be of the well known water-skiing type which do not support a load but rather use dynamic water pressure generated by moving across the surface of a body of water. In this application, the apparatus of this invention would necessarily be towed by a boat of sufficient power to move the instant apparatus at an appropriate speed. In an alternate embodiment, the skis 30, 30′ and 30″ are constructed with greater width and height than those shown in the figures so as to generate floatation so that they will support the apparatus and a rider on the surface of a body of water without the necessity of being towed. In this case, the apparatus may be useful for “skiing” along with a fast moving river of the sort used for white water rafting. In a still further alternative embodiment, the instant apparatus may be outfitted with a drive motor and propeller for generating thrust for use of the apparatus on water. Alternatively, one of skill would have little trouble in providing for mechanized propulsion of the present invention whether outfitted for use on water, snow, ice, or even a dry hard surface. Finally, the apparatus may be outfitted with ice runners affixed to the bottoms of the skis 30, 30′ and 30″ or in place of the skis for use of the instant invention on ice. In this mode the apparatus may be towed by a horse or dog. It would be possible for one of skill in the art to adapt the instant preferred embodiment to any of the alternative uses described herein without losing the general novelty and usefulness of the present invention.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A ski riding apparatus comprising: a horizontal platform having a forward end and an opposing rearward end, and an up-facing surface and an opposing down-facing surface; a rear ski engaged with the down-facing surface at the rearward end of the platform for support thereof; a steering column engaged with and extending upwardly from the up-facing surface for support and leverage in tilting the platform from side to side; the forward end of the platform rotationally engaged with a lateral ski support positioned forward of the platform, the ski support providing dual, spaced apart front skis, a drive train within the lateral ski support engaged with the forward end of the platform and the front skis so that tilting of the platform to one side or the other thereof drives the front skis to tilt cooperatively.

2. The apparatus of claim 1 wherein the front skis are rotatable in a lateral sense for tilting the front skis onto edges thereof.

3. The apparatus of claim 1 wherein the steering column is of a length and type for engaging the trunk of a rider standing on the platform.

4. The apparatus of claim 1 wherein the steering column is enabled for rotation into contact with the platform for storage of the apparatus.

5. The apparatus of claim 1 wherein the platform provides plural apertures therein.

6. The apparatus of claim 1 wherein the platform provides a surface capable of scraping the sole of a foot cover.

7. The apparatus of claim 1 wherein the rear ski and the front skis each provide a concave bottom surface.

8. The apparatus of claim 1 wherein the rear ski and the front skis each provide opposing side edges, each of the side edges shaped so as to conform to a segment of a parabola.

9. The apparatus of claim 1 wherein the rear ski and the front skis each are pivotally engaged for rotation in the direction of movement of the apparatus on a surface.

10. The apparatus of claim 1 wherein the apparatus is enabled for disassembly for storage, whereby the skis are engaged with the platform by a means for engagement so as to be removable from the platform.
